(19) United States
(12) Patent Application Publication
(10) Pub. No.: US 2014/0268187 A1
(43) Pub. Date: Sep. 18, 2014

(54) SCOPE TURRET LABELING

(71) Applicant: Custom Turret Systems L.L.C., (US)

(72) Inventor: Daniel L. Nichols, Pleasant Grove, UT (US)

(73) Assignee: Custom Turret Systems L.L.C., Pleasant Grove, UT (US)

(21) Appl. No.: 13/829,181

(22) Filed: Mar. 14, 2013

(51) Int. Cl. G06K 15/02; G06T 11/20

(52) U.S. Cl. CPC G06K 15/024; G06T 11/206
USPC 358/1.4; 345/440

(57) ABSTRACT

Technology is described for generating a scope turret label. One method can include selecting scope information. A label image with a scale based on the scope information can be provided. A shooting condition can be selected. Scale numbering relative to the scale based on the shooting condition can be generated using a processor. The scale numbering can be provided on the label image.

### BACKGROUND

An individual can use various handheld weapons (i.e., arms) for hunting and target shooting. Of the various weapons that can be used for hunting and target shooting, a rifle (e.g., firearm or gun) can provide good accuracy at long distances (e.g., couple hundred yards or meters). Because accurately aiming a rifle can become more difficult as a distance to a target increases, a telescopic sight (i.e., scope) can be used to improve the view of the target and improve the accuracy of aiming and shooting at a desired position on the target.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates a diagram of a rifle with a telescopic sight (i.e., scope) in accordance with an example;

FIG. 2 illustrates a change in a bullet drop in yardage for a change in an environmental condition in accordance with an example;

FIG. 3 illustrates a diagram of a scope (i.e., a telescopic sight) in accordance with an example;

FIG. 4 illustrates a diagram of a reticle of a telescopic sight in accordance with an example;

FIG. 5A illustrates an affixed scope turret label on a scope turret in accordance with an example;

FIG. 5B illustrates an application of a scope turret label on a scope turret in accordance with an example;

FIG. 6 illustrates a wind direction relative to clock positions and a telescopic sight in accordance with an example;

FIG. 7 illustrates components of an example system for generating a scope turret label in accordance with an example;

FIG. 8 illustrates a user interface for generating a scope turret label in accordance with an example;

FIG. 9 illustrates a flow chart for generating a scope turret label in accordance with an example;

FIG. 10A illustrates numbering for a scope turret label to be used at a 600 foot (ft) elevation in accordance with an example;

FIG. 10B illustrates numbering for a scope turret label to be used at a 7000 foot (ft) elevation in accordance with an example;

FIG. 10C illustrates numbering for a scope turret label to be used at 0 degrees Fahrenheit (F) in accordance with an example;

FIG. 10D illustrates numbering for a scope turret label to be used at 80 degrees Fahrenheit (F) in accordance with an example;

FIG. 10E illustrates a scope turret label with three tiers in accordance with an example;

FIG. 10F illustrates a scope turret label with windage labeled in inches in accordance with an example;

FIG. 10G illustrates a scope turret label with a clockwise (CW) rotation in accordance with an example;

FIG. 10H illustrates a scope turret label with vertical rotation of yardage numbering in accordance with an example;

FIG. 10I illustrates a scope turret label with 25 yard marks in accordance with an example;

FIG. 10J illustrates a scope turret label with an inherent scale in accordance with an example;

FIG. 10K illustrates a scope turret label with a scale and numbering in accordance with an example;

FIG. 11 depicts a flow chart of a method for generating a scope turret label in accordance with an example;

FIG. 12 depicts a flow chart of another method for generating a scope turret label in accordance with an example;

FIG. 13A illustrates a scope turret measuring tool in accordance with an example;

FIG. 13B illustrates a scope turret measuring tool for measuring a height of a scope turret in accordance with an example;

FIG. 13C illustrates a scope turret measuring tool for measuring a perimeter (i.e., circumference) of a scope turret in accordance with an example; and

FIG. 14 illustrates a block diagram of a computing device for generating a scope turret label in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

### EXAMPLE EMBODIMENTS

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

FIG. 1 illustrates a rifle 200 (i.e., a bolt-action rifle) with a telescopic sight 210 (i.e., a scope). As used herein the scope is used interchangeably with the telescopic sight. A cartridge (also referred to as a round, a shell or ammunition) including a bullet can be loaded into firearm (e.g., rifle) and the bullet can be fired from a barrel 202 of the firearm. The end of the barrel can be referred to as a muzzle. A cartridge can package the bullet, propellant (e.g., smokeless powder or black powder), and a primer within a casing (e.g., metallic or plastic housing) that can be precisely made to fit within a firing chamber of a firearm. The primer can be a small charge of an impact-sensitive or electric-sensitive chemical mixture that can be located at the center of the case head (centerfire ammunition) or inside a rim (rimfire ammunition) of the cartridge. The speed and power of the bullet can be characterized by ballistic information, such as muzzle velocity. Ballistics can describe the mechanics that deals with the flight, behavior, and effects of projectiles, such as bullets. Muzzle velocity is the speed a projectile (e.g., bullet) has at the moment the projectile leaves the muzzle of the gun. The muzzle velocity of a bullet, which can be measured as feet per second (fps or ft/sec) or meters per second (m/s), can be determined in part by the size and/or weight of the bullet and the quantity of the propellant. The velocity of a projectile (e.g., bullet) can be highest at the muzzle and drops off steadily because of air resistance.

FIG. 2 illustrates a trajectory (300) for a 30-06 Springfield (7.62×63 millimeter (mm)), nosler ballistic tip, 165 grain weight bullet with a ballistic coefficient (BC) of 0.475. The trajectory 300 illustrates a bullet drop (in inches) 304 over a range (in yards) 302. In FIG. 2, the scope is sighted in at a 300 yard (312) zero (314) with a sight height of 1.5 inches. In an example, the sight height 250 (FIG. 1) can be a measure from a center of the scope to a center of the barrel. A baseline trajectory 322 can represent a trajectory with environmental conditions at default values (e.g. a 1000 foot (ft) elevation and 59° Fahrenheit (F)). With a change in the environmental conditions, such as an increase or decrease in elevation or an increase or decrease in temperature, the bullet can drop more rapidly 320 or can drop more slowly 324 than a baseline trajectory. Within a short range, such as a couple hundred yards, the change in environmental conditions can be negligible to the bullet drop, thus having negligible impact on estimates based on the baseline trajectory. But as the range increases, the environmental conditions can have a greater effect on the trajectory of the bullet, which can adversely affect the estimates and accuracy of hitting a specified target. Long range shooters can adjust for varying environmental conditions with adjustments to the scope of the rifle to improve their accuracy.

Referring back to FIG. 1, the scope 210 can be mounted on the rifle 200. The scope can be a sighting device that is based on an optical refracting telescope. The scope can be equipped with some form of graphic image pattern (e.g., a reticle) mounted in an optically appropriate position in the optical system to give an accurate aiming point. A user (e.g., shooter) can look through the ocular end 242 (e.g., eyepiece) of the scope to view the target through the objective end 244 of the scope, as shown in FIG. 3. The scope can have several adjustment controls, as shown in FIGS. 1 and 3. The adjustment controls can include an elevation control 212 (or vertical adjustment control) of the reticle, a windage control 214 (or horizontal adjustment control) of the reticle, a focusing control (not shown) at the ocular end of the sight, a zero-stop elevation control (not shown), a magnification control (not shown), an illumination adjustment control of the reticule (not shown), and a parallax compensation control (not shown). The focusing control can be used to obtain a sharp picture of the object and reticle. The zero-stop elevation control can be set to prevent inadvertently dialing an adjustment knob “below” a primary zero (e.g., 100 meters or 100 yards for long-range scopes), or at least prevent dialing more than a couple adjustment clicks below the zero. The zero-stop elevation control can be useful on long-range scopes because the zero-stop elevation control allows the shooter to physically verify that the elevation knob is dialed all the way down which can avoid confusion regarding the elevation status on a two-revolution or multi-revolution elevation knobs (e.g., turrets). The magnification control can be used to change the magnification by turning a ring that can be marked with several magnification power levels. The illumination adjustment control of the reticule can be used to regulate the brightness level of the lit parts of the reticles crosshairs. The parallax compensation control can correct problems that result from an image from the objective lens not being coincident with the reticle. If the image is not coplanar with the reticle (i.e., that is the image of the objective is either in front of or behind the reticle), then putting your eye at different points behind the ocular can cause the reticle crosshairs to appear to be at different points on the target. This optical effect causes parallax induced aiming errors that can make a telescopic sight user miss a small target at a distance for which the telescopic sight was not parallax adjusted.

The elevation control 212 (or vertical adjustment control) of the reticle and a windage control 214 (or horizontal adjustment control) of the reticle can be adjusted using a knob or dial, such as a turret. As used herein the knob or dial used for an elevation control or a windage control can be referred to as a turret. FIG. 4 illustrates a duplex crosshair reticle 216, as seen from the ocular end 242 (e.g., eyepiece). A reticle (or reticule) can be a net of fine lines or fibers in the eyepiece (e.g., at the ocular end) of a sighting device, such as a telescopic sight. The reticle can include a horizontal reticle 220 (e.g., elevation reticle) and a vertical reticle 230 (e.g., windage reticle). Reticles can include typical cross hairs (e.g., fine crosshairs or duplex cross hairs), a German reticle, target dot, Mil-Dot, circle, range finding, or Snayperskaya Vintovka Dragunova (SVD) type (translated as “Dragunov's sniper rifle”). The SVD type was used in the Soviet PSO-1 (Pritsel Snaipersky Optichesky, “Optical Sniper Sight”) telescopic sight, which was a technically advanced telescopic sight at the time and designated for a marksman or sniper rifle. Crosshairs can be represented as intersecting lines in the shape of a cross, “+”.

The elevation turret 212 can be used to adjust a horizontal reticle 220 (e.g., elevation reticle) in a vertical direction, either up 222 or down 224. The windage turret 214 can be used to adjust a vertical reticle 230 (e.g., windage reticle) in a horizontal direction, either left 232 or right 234. The horizontal reticle can have additional small lines 228 or dots representing a specified angle or distance from a crosshair position in the field of view. In an example, the specified angle or distance can be represented as minutes of angle (MOA) or Mils. The MOA, a minute of arc, or an arcminute is a unit of angular measurement equal to one sixtieth ( 1/60) of one degree (e.g., 21,600 MOA per circle) or π/10,800 radians. Mil or milliradian ( 1/1000 of a radian) intervals can be represented by means of a mathematical formula. For example a width or height of the target divided by a number of mil of dots times 1000 equals a distance, thus a user can measure a range to a target. For instance, an object of 1 meter tall or wide is 1 Mil tall or wide at 1000 meters distance. If the user sees an object of 1.8 m tall for example as three mil dots tall through the riflescope the object is at 600 m distance (e.g., (1.8 m/3 mil)×1000 mil=600 m). An angular mil, also mil, can be a unit of angle. The angular mil can be approximately the same size as a trigonometric milliradian. Likewise, the vertical reticle can have additional small lines 238 or dots representing the specified angle (e.g., MOA or Mil) or distance (e.g., Mil) from the crosshair position.

In an example, the elevation turret or the windage turret can be engraved or labeled with a scale. In another example, the scale can be based on clicks, MOA, or Mils. Each click can be a discrete position of the turret representing a specified adjustment of the reticle (e.g., elevation or windage). For some scopes, a user can feel the clicks while adjusting the turret. For example, each click can represent 1/10, ⅛, ⅙, ¼, ⅓, ½, or 1 MOA or Mil.

FIG. 5A illustrates an elevation scope turret 212 with a scale 280, numbering including distance numbering (e.g., yardage 282 or meter value) and windage numbering 284 (e.g., windage values), and a default description 286. Each mark of the scale can represent a click value. In an example, the numbers of the scale can represent click values, MOA, or Mils. The numbering (e.g., yardage or meter value) can be spaced relative to the scale based on ballistic and environmental conditions. FIGS. 5A-B represents a turret for a specified scope with a bullet with muzzle velocity of 2800 fps operating at a 1000 ft elevation and a temperature of 59° Fahrenheit (F), which can be indicated with a description 286 on the turret. FIG. 5B illustrates a label 272 being applied to the elevation scope turret. In the example of FIG. 5B, the underlined “1” 288 represents a scope sighted in or zeroed at a 100 yards (or meters). In FIG. 5B, the elevation turret 212 provides the distance numbering (e.g., yardage) and scale for adjusting the elevation reticle for a target between approximately 100 and 650 yards (or meters) for a specified scope, a cartridge, and default environmental condition. The windage value indicates a number of MOA, Mils, or inches that the windage reticle can be adjusted for accurate aiming for a specified wind speed and direction. A wind characterized by wind speed and wind direction can move a bullet either to the right or the left of a center position (without wind), which can be more extreme at farther distances. For example, at a shooting distance of 500 yards (or meters) with the specified wind speed and direction, the user needs to adjust the windage reticle to the right or left (depending on whether the wind is coming from the right or left) by just over 3.5 MOA or Mils to hit the desired target. Alternatively, a user can aim at 3.5 MOA (or Mils) to the right or left of the crosshair position using the small lines 228 (FIG. 4) or dots indicating MOA (or Mils) on the horizontal reticle, instead of adjusting the windage reticle.

FIG. 6 illustrates wind direction 270 relative to clock positions 260 with the scope 210 as a reference for a clock. A 12 o'clock position represents the direction of the target and a 6 o'clock position represents a direction of a shooter. A 12 o'clock wind can be referred to as a head wind, a 6 o'clock wind can be referred to as a tail wind, a 9 o'clock wind can be referred to as a side wind from the left, and 3 o'clock wind can be referred to as a side wind from the right. A wind can have a forward-backward wind (head wind or tail wind) component and a side wind (left wind or right wind) component. The side wind component can have more significant impact on bullet dynamics and accuracy than the forward-backward wind component. A 3 or 9 o'clock wind can have mainly the side wind component without the forward-backward wind component. A 12 or 6 o'clock wind can have mainly the forward-backward wind component without the side component. The side wind component can be calculated as approximately as the cosine (cos) of an angle (θ) from a side wind direction. For example, the side wind component from a 2 o'clock wind (30° from 3 o'clock) is cos 30° or approximately 86.6% of a side wind, and the side wind component from a 1 o'clock wind (60° from 3 o'clock) is cos 60° or approximately 50% of a side wind. So, if a 1 o'clock wind was 10 miles per hour (mph or MPH), then the side wind would be 5 mph. And if a 2 o'clock wind was 10 miles per hour (mph), then the side wind would be 8.66 mph. The side wind component of all the clock positions on the clock can be calculated from one of the quadrants of the clock (e.g., 12 o'clock to 3 o'clock), but may use a different direction (e.g., right or left). For example, 2, 4, 8, and 10 o'clock have approximately a same absolute value of the side wind component, and 1, 5, 7, and 11 o'clock have approximately the same absolute value of the side wind component.

A long range shooter may want a customized turret for a specified scope, firearm, cartridge, and/or shooting condition to better estimate the trajectory of the bullet and improve the accuracy of hitting a long-range target. The shooting condition can include ballistics information and environmental information. In order to obtain a customized turret, a user (e.g., long range shooter) may order a custom engraved turret from a scope manufacture based on a variety of information and conditions, which can be expensive each time a user changes a condition. A less expensive option can be to print a label customized to a specified scope, firearm, cartridge, and/or shooting condition, and applying the label to an existing turret structure. In an example, the label can be available to a user in a couple of minutes. In another example, a turret label can be less than 20% of the cost of a laser engraved turret. In a configuration, the turret label can be printed on materials to provide similar durability to the laser engraved turret for a lot less cost. For example, the turret label can be waterproof, ultra-violet (UV) radiation resistant, sticky on the surface applied to the turret, and scratch resistant. The turret labels can be printed on a material that is designed to be waterproof and freeze proof Using durable materials, the turret labels can be submerged in water for hours without any damage to the turret labels. Turret labels can withstand heat (e.g., over 100 degree temperatures), wind, and rain with minimal to virtually no fading. The turret labels can use an adhesive that is very strong and designed for outdoor use to prevent or reduce curling on the edges. The turret labels can use a very thin clear laminate coating over the top that forms a barrier for a printed paper underneath. The coating can be designed to be extremely tough and resist scratching.

Technology (e.g., a system, method, device, or graphical user interface) can be used to generate a scope turret label. FIG. 7 illustrates components of an example system for generating the scope turret label. In particular, a network environment 100 may be used to implement the functionality provided by the graphical user interface 400 (FIG. 8) further discussed in examples below. The networked environment 100 may include one or more computing devices 110, and client devices 170 connected to the computing device 110 by way of a network 165.

The network 165 may include any useful computing network, including an intranet, the Internet, a local area network (LAN), a wide area network (WAN), a wireless data network, or any other such network or combination thereof, and may utilize a variety of protocols for transmission thereon, including for example, Internet Protocol (IP), the transmission control protocol (TCP), user datagram protocol (UDP) and other networking protocols. Components utilized for such a system may depend at least in part upon the type of network and/or environment selected. Communication over the network may be enabled by wired or wireless connections and combinations thereof.

As depicted in the example system, each client device 170 may each have a turret labeling application 180 and a display 185 connected to the client device. The turret labeling application may be a standalone application which can execute on the client device. Additionally, the client device may have a web browser 175 with the turret labeling application 180 provided. By employing the web browser, the client device may be configured to retrieve information from the network 165 and render the retrieved information on the display. Other client devices 170 may include additional or alternative software such as a web browser add-on or so called fat clients which typically provide increased functionality independent of a central server by executing additional logic directly on the client devices.

A client device 170 may be a device such as, but not limited to, a desktop computer, a laptop, a tablet, a mobile device, a television, a cell phone, a smart phone, a hand held messaging device, a set-top box, a gaming console, a personal data assistant, an electronic book reader, or any device with a display that may receive and present the information. The client device(s) may be used to view visualizations generated by the network module 190, scale module 150, numbering module 155, and/or graphics module via a turret labeling application 180 by communicating with the computing device 110 over the network 165.

The computing device 110 may comprise, for example, a server computer or any other system providing computing capability. Alternatively, a plurality of computing devices 110 may be employed that are arranged, for example, in one or more server banks or computer banks or other arrangements. For purposes of convenience, the computing device may be referred to in the singular, but it is understood that a plurality of computing devices may be employed in the various arrangements as described above.

Various processes and/or other functionality, as discussed herein, may be executed in the network environment 100 according to various examples. The computing device 110, may for example, provide some central server processing services while the client devices may provide local processing services and interface processing services to interface with the services of the computing device. Therefore, it is envisioned that processing services, as discussed herein, may be centrally hosted functionality or a service application that may receive requests and provide output to other services or customer devices.

For example, modules providing services may be considered computing that are hosted in a server, cloud, grid, or cluster computing system. An application program interface (API) may be provided for each service to enable a second service to send requests to and receive output from the first service. Such APIs may also allow third parties to interface with the service and make requests and receive output from the service. Third parties may either access the modules using authentication credentials that provide on-going access to the module or the third party access may be based on a per transaction access where the third party pays for specific transactions that are provided and consumed. In the depicted example, a processor 112 may provide processing instructions by communicating with a memory 118. That is, the memory device may include instructions operable to be executed by the processor to perform a set of actions. The processor 112 and/or the memory 118 may directly or indirectly communicate with a data store 115. Storage memory can include the memory and/or the data store.

Various data may be stored in a data store 115 that is accessible to the computing device 110. The term “data store” may refer to any device or combination of devices capable of storing, accessing, organizing and/or retrieving data, which may include any combination and number of data servers, relational databases, object oriented databases, cloud storage systems, data storage devices, data warehouses, flat files and data storage configuration in any centralized, distributed, or clustered environment. The storage system components of the data store 255 may include storage systems such as a SAN (Storage Area Network), cloud storage network, volatile or non-volatile RAM, optical media, or hard-drive type media. The data store 255 may be representative of a plurality of data stores 255.

The data stored in the data store 115 may include, for example, detailed information about scope data 120, shooting conditions data including ballistics data 125 and environmental data 130, custom data 135, style data, and user data or user profile 145 information. The data store can include bullet drop tables, bullet trajectory tables, drag functions, drag curve models, compensating functions, and similar tables and functions for generating a scope turret image or scope turret label. In an example, the table and functions can be downloaded or otherwise loaded into the data store.

The scope data 120 (or scope information) can include a turret diameter, a turret circumference, a turret height, a click value relative to minutes of angle (MOA) or Mils, and clicks per revolution for a specified scope. The scope data can also include a list of scopes based on a scope manufacturer and a scope model, and a specified scope can be associated with the scope data. A scale (280 of FIGS. 5A-B) for the turret label can be derived from the specified scope or the scope data stored in a data store.

The shooting conditions data (or shooting conditions information) can include ballistics data 125 (or ballistics information) and environmental data 130 (or environmental information). Ballistics data can include a ballistic coefficient (BC), a drag coefficient, a drag function, a muzzle velocity, a zero sight-in distance, and a scope height from a gun bore. The ballistics data can be derived from ammunition data including a bullet weight, a bullet shape, a cartridge type, a shell type, an ammunition manufacturer, a propellant quantity, a propellant type, a primer type, and/or a gun caliber. The environmental data can include an altitude, a temperature, a barometric pressure, a wind speed, and a wind direction. In an example, a barometric pressure can be used instead of the altitude and the temperature.

The custom data 135 (or custom information) can include descriptions, units for scales, windage, clicks, number of displayed tiers, scales, numbering, or sub-numbering customized for a user. The style data 140 (or style information) can include a user label description, a number of tiers, a number of revolutions for distance, a number alignment, a windage, a font style, a font size, a font color, a tier color, a user label description color, a clicks color, a windage color, and a sub-numbering scale. The user data (or user profile or user information) can include scope data, shooting conditions data, custom data, style data, a label image, a scale, or a scale numbering associated with a user identifier. The user data can include a user name, the user identifier, a user address, a user email, a user telephone number, user contact information, a credit card number with associated information, a debit card number with associated information, or an identifier for a payment mechanism.

In another example, users may also be identified via various methods, such as a unique login and password, a unique authentication method, an Internet Protocol (IP) address of the user's computer, an HTTP (Hyper Text Transfer Protocol) cookie, a GPS (Global Positioning System) coordinate, or using similar identification methods.

Various modules may be included or loaded within the computing device 110, including for example, a scale module 150, a numbering module 155, a graphics module 158, a printing module 160, and a network module 190. The scale module 150 can be used to generate a scale (e.g., the clicks, MOA, or Mils) for a scope turret image, which scope turret image can be printed to generate a scope turret label. The scale module can use the scope data and other data to generate the scale for the scope turret image. The number module 155 can be used to generate a numbering (e.g., distance (yardage or meters) to the target or windage) relative to the scale for the scope turret image. The numbering can be based on the shooting conditions data and other data to generate the numbering relative to the scale for the scope turret image. The graphics module 158 can be used to generate a display for the client device 170 turret labeling application 180, which can include the scope turret image, a scope turret image rendering area, and user selection fields for scope data, shooting conditions data, custom data, style data, and user data. User selection fields can include data fields, radio buttons, and check boxes. The client device display 185 can display the information generated by the graphics module. The display screen can be configured to display the scope turret label image based on a user selection of style data. The network module 190 can manage a network interface with client devices 170 or a printer 195.

In an example, the computing devices 110 can include a purchase module (not shown) to activate printing of the scope turret label, where printing can be activated with valid payment information. The print module 160 can generate the information for a printer 195 to print the scope turret label from the scope turret image including the scale and the scale numbering, where the scope turret label is configured to be attached to the scope turret.

In an example, the processor expands or contracts spacing of a scale numbering (e.g., yardage, meters, or windage) or a sub-numbering scale (e.g., 50 or 25 yard or meter increment marks) relative to the scale based on a change of the shooting conditions. In another example, the processor is configured to select default scope information and default shooting conditions from the data store (e.g., storage memory) when no user information is provided for a field of scope information or shooting conditions.

FIG. 8 illustrates an overview of an example graphical user interface (GUI) 400 that may advantageously utilize various aspects of the technology. In an example, a graphical user interface may be provided through a web browser (175 of FIG. 7). The web browser may have navigated to a specific uniform resource locator (URL) address. Upon navigating to the specific URL address, the graphical user interface may request that a user login to the interface. Other types of computer applications may also be appropriate for interacting with embodiments of this disclosure, including for example, a standalone client application or a downloadable app.

The user interface (e.g., GUI 400) can include a scope selection control group 410 for entering scope information; a shooting conditions selection control group 430 for entering shooting conditions; a turret label rendering area 470 for displaying a turret label image 472 representing a scope turret label; a style selection control group 458 for modifying the style of the turret label image based on entered style information; a custom selection control group 452, 454, and 456 for customizing descriptions 452, units for scales, windage, clicks, number of displayed tiers 454, scales, numbering, or sub-numbering for a user; or a payment control group (not shown) including payment information for activating a printer to print the scope turret label or activating a display to display the turret label image. A check out button 496 can be used to advance the GUI to another view, such as the payment control group. The style group can be grouped with the custom group to form a style-custom selection control group 450.

FIG. 8 illustrates a turret label image for a 300 Winchester Magnum 190 grain very low drag (VLD) bullet with a muzzle velocity of 3100 fps with a shorten description of “300 WIN MAG 190 g VLD 3100 fps” 488. The description can be specified in a custom description field 452. The turret label image 472 can include a scale 474 based on the scope information and numbering of the scale based on the shooting conditions, where a spacing of the numbering relative to the scale can vary based on a change of the shooting conditions. The scale can include numbers for MOA 480, Mils, or clicks. The numbering can include multiple tiers 484 and 482 of information related to distance (yardage or meters) to a target and windage 490. The turret image can include an alignment line 476 representing a zero sight in yardage (or meters) used for alignment with an existing turret structure at a zeroed position. For example, when a turret label is applied, a zero value on the scale 474 can align (or overlap) the alignment line 476, so the distance from the alignment line to the zero value on the scale represents the circumference or perimeter of the scope turret. FIG. 8 illustrates a scope turret label zeroed (278) at 250 yards (or meters).

Some turrets can be adjusted over multiple revolutions (360° turns). As illustrated in FIG. 8, a turret can use a first tier 482 of yardage information for shooting distances 250 yards to approximately 850 yards and use a second tier 484 for shooting distances approximately 900 to 1275 yards.

The shooting conditions selection control group 430 can include a list of scopes based on a scope manufacturer and a scope model, which can be referenced by a scope name. In an example, a selection of the scope by the scope manufacturer and the scope model can auto populate the scope data. Alternatively, a user can use a custom scope user entry for the scope data. The click value can be selected to be displayed in MOA or Mils. Each click can represent 1/10, ⅛, ⅙, ¼, ⅓, ½, or 1 of a MOA or a Mil. A clicks per revolution (e.g., 60), a turret diameter, a turret circumference or perimeter (e.g., 30 from a scope turret measuring tool), a turret height (e.g., 25.5 from the scope turret measuring tool), a tool (e.g., a caliper or a scope turret measuring tool) used to generate the turret measurements, and turret rotation (clockwise (CW) or counter clockwise (CCW)) for lowering the elevation reticle can also be selected. When scope information is selected a scope turret image with a scale can be displayed in the scope turret rendering area. In an example, the rendering area can also include a size referencing marker (e.g., currency, such as penny or dime) near the scope turret image, which can provide a size reference to a user (e.g., customer) to assist them in determining an relative size of the scope turret image used for the scope turret label. Alternatively, a system can provide a print feature allowing a user to partially print a scope turret label to give a user a size reference before purchasing a complete scope turret label.

In another example, a default scope turret image can be displayed with default entry fields, and different scope turret image can be displayed with a different selection of scope data. In another configuration, a separate button (e.g., calculate button) can be used to calculate a different scale and display the scale with the scope turret image each time the button is selected.

The shooting conditions selection control group 430 can include fields for entering shooting conditions. Shooting conditions information can include ballistics information and environmental information. The distance measurement numbering can be generated in yards, meters, or other unit of distance. In an example, each distance measurement numbering or mark can be manual placed using a cursor or other pointing mechanism, or each distance measurement numbering or mark can be adjusted from a default position. The user can advance to a custom distance numbering view by a selection of a custom button in the shooting conditions selection control group 430. In another example, a user can select a position of two custom distance numbering values on the scale of scope turret image, and a processor can generate remaining distance numbering and spacing based on available information (e.g., cartridge information or muzzle velocity) and bullet drop tables or trajectories based on the available information.

In another example, the user can select the shooting conditions, such as a zero value (e.g., 250 yards), a wind direction in o'clock (e.g., 3:00), an altitude (e.g., 7000 ft), a temperature (e.g., 38° F.), a wind speed (e.g., 10 MPH), a humidity (e.g., 20%), a pressure, a scope height (e.g., 2.05, see 250 of FIG. 1), a muzzle velocity (e.g., 3100), a ballistic coefficient (B.C.; e.g., 0.57), and a drag curve model (e.g., G1 or G7). In an example, a pressure may be used as a substitute for altitude and temperature.

The ballistic coefficient (BC or B.C.) of a body (e.g., bullet) is a measure of the body's ability to overcome air resistance in flight. The BC is inversely proportional to the negative acceleration, thus a high BC value indicates a low negative acceleration. The BC can be a function of mass, diameter, and drag coefficient. The BC can also be given by the mass of the object (e.g., bullet) divided by the diameter squared that the object presents to the airflow divided by a dimensionless constant i (e.g., i=form factor) that relates to the aerodynamics of the objects shape. The BC can be represented mathematically by

$$BC = \frac{M}{{C}_{d} \cdot A} ,$$

where M is a mass of the object, A is a cross-sectional area of the object, and C_{d} is a drag coefficient of the object. The BC can have units of lb/in² or kg/m². The BCs for bullets can stated in lb/in² by their manufacturers without referring to a unit. For a bullet, BC can be represented by

$$BC = \frac{SD}{i} = \frac{M}{i \cdot {d}^{2}} ,$$

where SD sectional density (i.e., a mass of bullet in pounds or kilograms divided by the bullet caliber squared in inches or meters, where units are lb/in² or kg/m²), M is the mass of the bullet (in pounds (lb) or kilograms (kg)), d is a diameter of the bullet (in inches (in) or meters (m)), i is a form factor represented by

$$i = \frac{{C}_{B}}{{C}_{G}} ,$$

where C_{d} is a drag coefficient of the bullet, and C_{G} is a drag coefficient of a G1 model bullet.

Different bullet types or shapes can have different drag curve models. A G1 and G7 drag curve model is often used for bullets used in long distance shooting, but other drag curve models may also be used. For example, G1-G8, GL, and G1 can be used for their drag curve models. G1, G1, or Ingalls is a flatbase with 2 caliber (blunt) nose ogive, which can be very popular. G2 is an Aberdeen J projectile. G5 is a short 7.5° boat-tail, 6.19 calibers long tangent ogive. G6 is a flatbase, 6 calibers long secant ogive. G7 is a long 7.5° boat-tail, 10 calibers tangent ogive, which can be preferred by some manufacturers for very-low-drag (VLD) bullets. G8 is a flatbase, 10 calibers long secant ogive. GL is blunt lead nose. The BC can be different for different drag curve models.

In an example, a default shooting condition can be set with a distance measurement in yards, a zero at 100 yards, a 3:00 wind direction, a 2000 ft altitude, a 59° F. temperature, a 10 MPH wind speed, 50% humidity, a 29.92 inches (in mercury (Hg)) pressure (representing pressure at sea level when pressure is used), a scope height of 1.5 inches, a muzzle velocity of 2600 fps, a BC of 0.5, and a G1 drag curve model. In an example, the default shooting condition can be modified by a user.

The custom selection control group can include fields for entering customizing the appearance of the scope turret image. For example, the number of distance numbering (e.g., yardage or meters) revolutions or tiers 454 (e.g., one to six). A tier selection may be modified if a turret height is too small for a number of tiers selected. A processor may enforce a minimum font or minimum size of markings for a scale for the scope turret image (and scope turret label). A user can generate a description 452 that can be displayed 488 on the scope turret image 472. A user can select features to be displayed such as windage (in MOA, Mils, or inches) and click number or markings (in MOA, Mils, or inches), the description (e.g., add info), and sub-numbering (e.g., 50 yard or 25 yard marks).

The style selection control group 458 can include fields for modifying the style or appearance of the turret label image based on entered style information. For example, a user can select a font style, a font size, a font color, and alignment direction of the distance measurement (e.g., 90° for horizontal rotation (as shown) or 0° for vertical rotation (see 356 of FIG. 10H). In an example, a user can include a different color for click marking or numbering, windage numbering, the description (e.g., info), and each tier of distance measurements (and windage, when used).

FIG. 9 illustrates a flow chart 800 for generating a scope turret label. Technology (e.g., a system, method, device, or GUI) can provide a default scope information, default shooting conditions, and default style 802. The system can provide a default label (e.g., scope turret image) with a default scale with default scale numbering (e.g., distance or windage) using a default style 804. The default scale can be generated from the default scope information. The default scale numbering can be generated from default shooting conditions. The system can check to see if the scope information changed 806. When the scope information changes, the system can provide a different label image 808 (i.e., a different scope turret image) with a scale or modify the label image with a different scale. The system can check to see if the shooting conditions changed 810. When the shooting conditions change, the system can generate different scale numbering relative to the scale 812. The system can check to see if the style information changed 814. When the style information changes, the system can modify format or the appearance of the label image for the scale numbering or the scale 816. The system can display the label image with the scale numbering 818. The user can continue making changes until the scope turret image has the desired appearance. The user can interactively view changes to a scope turret image (e.g., label image) based on scope information, shooting conditions, and style information. The system can determine when the user is finished 820 entering changes. When a user is finished the user can print scope turret label 824, such as using a purchased stand-alone scope turret application. Alternatively, the user can purchase a scope turret label 822, such as at a kiosk or using web application, and when the payment information is verified, the system can activate printing of the scope turret image so the scope turret label can be printed 824 (and sent to the user when the printer is not in close proximity to the user).

The technology (i.e., system, method, device, or GUI) for generating a scope turret label described has several advantages over laser engraved turrets and ordering laser engraved turrets. The technology allows a user to view and modify a scope turret label to a desired appearance before printing a label. In some applications, a label can be printed shortly after the desired scope turret image has been selected and the scope turret label applied to the turret structure, which can allow for adapting to dynamic changes in shooting conditions. For laser engraved turrets, a user may have to wait a couple of days to couple weeks to get a custom turret. The technology can be much cheaper that buying a new laser engraved turret for each change in a shooting condition, which can allow for more changes and fine tuning of the shooting conditions for the same cost.

FIGS. 10A-K illustrate various scope turret labels that can be generated using the technology for generating a scope turret labels. FIGS. 10A-B illustrates how a change in elevation expands or contracts the distance numbering and windage numbering holding other shooting conditions constant. For example, FIG. 10A is designed for use at a 600 foot elevation 342 and FIG. 10B is designed for use at a 7000 foot elevation 344. At higher elevations, the bullet drop can be reduced and air resistance can be reduced, so the distance numbering (e.g., yardage 350) can contract, and the windage 352 can expand.

FIGS. 10C-D illustrates how a change in temperature expands or contracts the distance numbering and windage numbering holding other shooting conditions constant. For example, FIG. 10C is designed for use at a 0° F. temperature 346 and FIG. 10D is designed for use at a 80° F. temperature 348. At lower temperature, the bullet drop can be increase, so the distance numbering (e.g., yardage 350) can expand, and the windage 352 can contract.

FIG. 10E illustrates a scope turret label with three tiers 482, 484, and 486. FIG. 10F illustrates a scope turret label with windage 354 labeled in inches. FIG. 10G illustrates a scope turret label with a clockwise (CW) rotation. For example, the lower distance numbering (e.g., zeroed at 500 yards) is on the left and higher distance numbering is on the right (e.g., 800 yards). For a counter clockwise rotation, the lower distance numbering is on the right and higher distance numbering is on the left. FIG. 10H illustrates a scope turret label with vertical rotation 356 of distance numbering (e.g., yardage numbering). FIG. 10I illustrates a scope turret label with sub-numbering (e.g., 25 yard marks 358). FIG. 10J illustrates a scope turret label with an inherent scale. An inherent scale has a specified circumference or perimeter of the turret structure used, but a scale with click, MOA, or Mil marks or numbering may not be shown, displayed, or printed. FIG. 10K illustrates a scope turret label with a scale with click, MOA, or Mil marks but not click, MOA, or Mil numbering.

Another example provides a method 500 for generating a scope turret label, as shown in the flow chart in FIG. 11. The method may be executed as instructions on a machine or computer circuitry, where the instructions are included on at least one computer readable medium or one non-transitory machine readable storage medium. The method includes the operation of selecting scope information, as in block 510. The operation of providing a label image with a scale based on the scope information follows, as in block 520. The next operation of the method can be selecting a shooting condition, as in block 530. The operation of generating scale numbering relative to the scale based on the shooting condition using a processor follows, as in block 540. The method can further include providing the scale numbering on the label image, as in block 550.

In an example, the operation of generating scale numbering relative to the scale varies spacing between numbers or a sub-numbering scale based on a change of the shooting conditions. The method can further include the operations of displaying the label image with a scale, and displaying the scale numbering on the label image. In another example, the method can further include the operation of printing a label including the scale and the scale numbering, where the label is configured to be attached to a scope turret.

The operation of selecting the scope information can further include selecting a custom user entry including scope data, and selecting a list of scopes based on a scope manufacturer and a scope model. The scope data can include a turret diameter, a turret circumference, a turret height, a click value relative to minutes of angle (MOA) or Mils, or clicks per revolution. The scale can be derived from the scope data stored in a data store.

The operation of selecting the shooting condition can further include selecting ballistics information and environmental information. The ballistics information can include a ballistic coefficient (BC), a drag coefficient, a drag function, a muzzle velocity, a zero sight-in distance, or a scope height from a gun bore. The environmental information can include an altitude, a temperature, a barometric pressure, a wind speed, or a wind direction. The ballistics information can be derived from user data, where user data includes a bullet weight, a bullet shape, a cartridge type, a shell type, an ammunition manufacturer, a propellant quantity, a propellant type, a primer type, or a firearm caliber.

In another example, the method can further include the operation of modifying the label image based on style information. The style information can include a user label description, a number of tiers, a number of revolutions for distance, a number alignment, a windage, a font style, a font size, a font color, a tier color, a user label description color, a clicks color, a windage color, or a sub-numbering scale. In another configuration, the method can further include the operation of storing the scope information, the shooting condition, style information, the label image, the scale, or the scale numbering associated with a user identifier.

Another example provides a method 600 for generating a scope turret label, as shown in the flow chart in FIG. 12. The method may be executed as instructions on a machine or computer circuitry, where the instructions are included on at least one computer readable medium or one non-transitory machine readable storage medium. The method includes the operation of receiving a scope turret label input form including fields for scope information and shooting conditions, as in block 610. The operation of receiving a user entry of the scope turret label input form to generate a scope turret label output data follows, as in block 620. The next operation of the method can be sending the scope turret label output data for processing, as in block 630. The operation of receiving a scope turret label image including a scale and a numbering based on the scope information and shooting conditions of the scope turret label output data follows, as in block 640. The method can further include providing the scope turret label image for display on a display screen, as in block 650.

In another example, the method can further include the operation of receiving, from a server at a client device, a payment form including fields for payment information, and sending payment information to the server to activate a printer to print the scope turret label. The fields for payment information include a user name, a user identifier, a user address, a user email, a user telephone number, user contact information, a credit card number with associated information, a debit card number with associated information, or an identifier for a payment mechanism.

In another configuration, the scope information includes a custom scope user entry including scope data, or the scope information includes a list of scopes based on a scope manufacturer and a scope model, and the scale can be derived from the scope data. The scope data can include a turret diameter, a turret circumference, a turret height, a click value relative to minutes of angle (MOA) or Mils, or clicks per revolution.

The shooting conditions can include ballistics information and environmental information. The ballistics information can include a custom ballistics user entry including ballistics data or ammunition data, where the ballistics data can be derived from the ammunition data. The ballistics data can include a ballistic coefficient (BC), a drag coefficient, a drag function, a muzzle velocity, a zero sight-in distance, and a scope height from a gun bore. The ammunition data can include a bullet weight, a bullet shape, a cartridge type, a shell type, an ammunition manufacturer, a propellant quantity, a propellant type, a primer type, or a gun caliber. The environmental information can include an altitude, a temperature, a barometric pressure, a wind speed, or a wind direction.

In another example, the scope turret label input form or the scope turret label output data can include style information. The style information can include a user label description, a number of tiers, a number of revolutions for distance, a number alignment, a windage, a font style, a font size, a font color, a tier color, a user label description color, a clicks color, a windage color, or a sub-numbering scale. The scope turret label image can vary based on the style information. The scale can vary spacing between numbers or a sub-numbering scale of the scope turret label image based on a change of the shooting conditions.

The height of a scope turret or a diameter (or a circumference) of the scope turret can be determined by a ruler, a caliper, or a scope turret measuring tool (e.g., custom turret system (CTS) tool). FIGS. 13A-13C illustrate a scope measuring tool 700. The turret height can be measured via the ruler or the scope turret measuring tool. The turret diameter can be measured via the caliper, which can be used to derive a turret circumference or a turret perimeter or the turret diameter can be entered directly into the system for generating a scope turret label and the processor can generate the turret circumference or the turret perimeter for the scope turret label. Using the caliper can add an additional expense for generating a scope turret label, and a caliper may not be readily available for a user. Instead of using the caliper, the scope turret measuring tool can be used to both measure the turret height (FIG. 13C) for the scope turret label via the height scale 710, and measure the turret circumference or the turret perimeter (FIG. 13B) for the scope turret label via a perimeter scale 720. The scope turret measuring tool can provide a low cost mechanism to obtain the scope turret 212 dimensions for generating a scope turret label. The perimeter scale can use a non-linear scale or a proprietary scale that does not correspond to metric units (e.g., millimeters) or English units (e.g., inches). For example, a scale might begin a zero value at a minimum perimeter for a scope turret. For instance, a scope turret may have a minimum circumference of at least one inch. The scope measuring tool can be printed on a flexible material, like a piece of paper. In an example, the scope measuring tool can correspond to metric units, English units, other dimensions, or tables (e.g., bullet drop tables or trajectory tables) in the technology for generating a scope turret label. As used herein, the scope turret measuring tool can be used interchangeably with tool.

A method for measuring a scope turret using the scope turret measuring tool can include starting with a wide end (an end with the height scale) of the tool, and using a small piece of pressure-sensitive tape (e.g., adhesive tape, sticky tape, or Scotch tape) and tape the wide end of the tool to the turret. For a more accurate measurement, the tool can be aligned horizontally to the turret, as shown in FIG. 13B. For some turrets, measuring the turret upside down resting the tool on a lip of the turret can achieve a better measurement. The tool can be wrapped around the turret. For better measurements, a bottom edge of the tool can meet back up with itself. The tool can be pulled tight to reduce any slack in the tool. The vertical line 730 can be used as a gauge to measure the perimeter (i.e., circumference) using the perimeter scale. The resolution used by the system or method of generating the scope turret label can be measured to a nearest half of a hash mark. For example, FIG. 13B measures 30 on the tool. Using the height markings (e.g., height scale) on the tool can measure the height of the turret, as illustrated in FIG. 13C. The height measurement can be the height of where a printed label will be attached, and not a total height of the turret. The turret height can be measured to a nearest half of a hash mark.

FIG. 14 is block diagram 900 illustrating an example of a computing device 910 that may be used for generating a scope turret label. In particular, the computing device 910 is illustrates a high level example of a device on which modules of the disclosed technology may be executed. The computing device 910 may include one or more processors 912 that are in communication with memory devices 920. The computing device may include a local communication interface 918 for the components in the computing device. For example, the local communication interface may be a local data bus and/or any related address or control busses as may be desired.

The memory device 920 may contain modules that are executable by the processor(s) 912 and data for the modules. Located in the memory device 920 are modules executable by the processor. For example, a scope module 924, a shooting conditions module 926, a style module 928, a user input module 930, a graphic module 932, and printing module 934, and other modules may be located in the memory device 920. The modules may execute the functions described earlier. A data store 922 may also be located in the memory device 920 for storing data related to the modules and other applications along with an operating system that is executable by the processor(s) 912.

Other applications may also be stored in the memory device 920 and may be executable by the processor(s) 912. Components or modules discussed in this description that may be implemented in the form of software using high programming level languages that are compiled, interpreted or executed using a hybrid of the methods.

The computing device may also have access to input/output (I/O) devices 914 that are usable by the computing devices. An example of an I/O device is a display screen 950 that is available to display output from the computing devices. Another example of an I/O device is a printer 940 that can be available to print output (e.g., a scope turret label or scope turret measuring tool) from the computing devices. Other known I/O device may be used with the computing device as desired. Networking devices 916 and similar communication devices may be included in the computing device. The networking devices 916 may be wired or wireless networking devices that connect to the internet, a LAN, WAN, or other computing network.

The components or modules that are shown as being stored in the memory device 920 may be executed by the processor(s) 912. The term “executable” may mean a program file that is in a form that may be executed by a processor 912. For example, a program in a higher level language may be compiled into machine code in a format that may be loaded into a random access portion of the memory device 920 and executed by the processor 912, or source code may be loaded by another executable program and interpreted to generate instructions in a random access portion of the memory to be executed by a processor. The executable program may be stored in any portion or component of the memory device 920. For example, the memory device 920 may be random access memory (RAM), read only memory (ROM), flash memory, a solid state drive, memory card, a hard drive, optical disk, floppy disk, magnetic tape, or any other memory components.

The processor 912 may represent multiple processors and the memory 920 may represent multiple memory units that operate in parallel to the processing circuits. This may provide parallel processing channels for the processes and data in the system. The local interface 918 may be used as a network to facilitate communication between any of the multiple processors and multiple memories. The local interface 918 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, floppy diskettes, CD-ROM, digital versatile disks (DVD) or other optical storage, magnetic cassettes, magnetic tapes, magnetic disk storage or other magnetic storage devices, magnetic hard drive, solid state drive, other medium for storing electronic data, or any other computer storage medium which may be used to store the desired information and described technology.

Circuitry can include hardware, firmware, program code, executable code, computer instructions, and/or software. A non-transitory computer readable storage medium can be a computer readable storage medium that does not include signal.

One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Reference throughout this specification to “an example” means that a particular feature, structure, or characteristic described in connection with the example is included in at least one embodiment of the present invention. Thus, appearances of the phrases “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for generating a scope turret label, comprising:
selecting scope information;
providing a label image with a scale based on the scope information;
selecting a shooting condition;
generating scale numbering relative to the scale based on the shooting condition and the scope information, using a processor; and
providing the scale numbering on the label image.

2. The method as in claim 1, wherein generating scale numbering relative to the scale varies spacing between numbers or a sub-numbering scale based on a change of the shooting conditions.

3. The method as in claim 1, further comprising:
displaying the label image with a scale; and
displaying the scale numbering on the label image.

4. The method as in claim 1, further comprising:
printing a label including the scale and the scale numbering, wherein the label is configured to be attached to a scope turret.

5. The method as in claim 1, wherein selecting the scope information includes:
selecting a custom user entry including scope data selected from the group consisting of a turret diameter, a turret circumference, a turret height, a click value relative to minutes of angle (MOA) or Mils, and clicks per revolution; or
selecting a list of scopes based on a scope manufacturer and a scope model, wherein the scale is derived from the scope data stored in a data store.

6. The method as in claim 1, wherein selecting the shooting condition includes selecting ballistics information and environmental information, wherein:
the ballistics information is selected from the group consisting of a ballistic coefficient (BC), a drag coefficient, a drag function, a muzzle velocity, a zero sight-in distance, and a scope height from a gun bore; and
the environmental information is selected from the group consisting of an altitude, a temperature, a barometric pressure, a wind speed, and a wind direction.

7. The method as in claim 6, wherein the ballistics information is derived from user data selected from the group consisting of a bullet weight, a bullet shape, a cartridge type, a shell type, an ammunition manufacturer, a propellant quantity, a propellant type, a primer type, and a gun caliber.

8. The method as in claim 1, further comprising:
modifying the label image based on style information, wherein the style information is selected from the group consisting of a user label description, a number of tiers, a number of revolutions for distance, a number alignment, a windage, a font style, a font size, a font color, a tier color, a user label description color, a clicks color, a windage color, and a sub-numbering scale.

9. The method as in claim 1, further comprising:
storing the scope information, the shooting condition, style information, the label image, the scale, or the scale numbering associated with a user identifier.

10. At least one non-transitory machine readable storage medium comprising a plurality of instructions adapted to be executed to implement the method of claim 1.

11. A system for generating a scope turret label comprising:
a storage memory module to store scales relative to scope information and store shooting conditions;
a processor to generate a scale including scale numbering based on the scope information and shooting conditions; and
a graphics module to generate a scope turret label image including the scale and the scale numbering.

12. The system as in claim 11, further comprising:
a display screen to display the scope turret label image including the scale and the scale numbering.

13. The system as in claim 12, wherein the storage memory is configured to store style information is selected from the group consisting of a user label description, a number of tiers, a number of revolutions for distance, a number alignment, a windage, a font style, a font size, a font color, a tier color, a user label description color, a clicks color, a windage color, and a sub-numbering scale; and the display screen is configured to display the scope turret label image based on a user selection of style information.

14. The system as in claim 11, further comprising:
a print module to print the scope turret label including the scale and the scale numbering, wherein the scope turret label is configured to be attached to a scope turret.

15. The system as in claim 11, wherein shooting conditions includes ballistics information and environmental information, and wherein:
the scope information includes:
a custom scope user entry including scope data selected from the group consisting of a turret diameter, a turret circumference, a turret height, a click value relative to minutes of angle (MOA) or Mils, and clicks per revolution, or
a list of scopes based on a scope manufacturer and a scope model, wherein the scale can be derived from the scope data; and
the ballistics information includes:
a custom ballistics user entry including ballistics data selected from the group consisting of a ballistic coefficient (BC), a drag coefficient, a drag function, a muzzle velocity, a zero sight-in distance, and a scope height from a gun bore, or
ammunition data selected from the group consisting of a bullet weight, a bullet shape, a cartridge type, a shell type, an ammunition manufacturer, a propellant quantity, a propellant type, a primer type, and a gun caliber, wherein the ballistics data can be derived from the ammunition data; and
the environmental information is selected from the group consisting of an altitude, a temperature, a barometric pressure, a wind speed, and a wind direction.

16. The system as in claim 11, wherein the processor expands or contracts spacing of the scale numbering or a sub-numbering scale relative to the scale based on a change of the shooting conditions.

17. The system as in claim 11, further comprising:
a purchase module to activate printing of the scope turret label, wherein printing is activated with valid payment information selected from the group consisting of a user name, a user identifier, a user address, a user email, a user telephone number, user contact information, a credit card number with associated information, a debit card number with associated information, and an identifier for a payment mechanism.

18. The system as in claim 11, wherein the processor is configured to select default scope information and default shooting conditions from the storage memory when no user information is provided for a field of scope information or shooting conditions.

19. A graphical user interface under a control of one or more computer systems, the graphical user interface having a scope turret label representation, comprising:
a scope selection control group for entering scope information;
a shooting conditions selection control group for entering shooting conditions; and
a turret label image representing a scope turret label including a scale based on the scope information and numbering of the scale based on the shooting conditions, wherein a spacing of the numbering relative to the scale varies based on a change of the shooting conditions.

20. The graphical user interface of claim 19, wherein shooting conditions includes ballistics information and environmental information, and wherein:
the scope information includes:
a custom scope user entry including scope data selected from the group consisting of a turret diameter, a turret circumference, a turret height, a click value relative to minutes of angle (MOA) or Mils, and clicks per revolution, or
a list of scopes based on a scope manufacturer and a scope model, wherein the scale can be derived from the scope data; and
the ballistics information includes:
a custom ballistics user entry including ballistics data selected from the group consisting of a ballistic coefficient (BC), a drag coefficient, a drag function, a muzzle velocity, a zero sight-in distance, and a scope height from a gun bore, or
ammunition data selected from the group consisting of a bullet weight, a bullet shape, a cartridge type, a shell type, an ammunition manufacturer, a propellant quantity, a propellant type, a primer type, and a gun caliber, wherein the ballistics data can be derived from the ammunition data; and
the environmental information is selected from the group consisting of an altitude, a temperature, a barometric pressure, a wind speed, and a wind direction.

21. The graphical user interface of claim 19, further comprising:
a style selection control group for modifying the style of the turret label image based on entered style information, wherein the style information is selected from the group consisting of a user label description, a number of tiers, a number of revolutions for distance, a number alignment, a windage, a font style, a font size, a font color, a tier color, a user label description color, a clicks color, a windage color, and a sub-numbering scale.

22. The graphical user interface of claim 19, further comprising:
a payment control group including payment information for activating a printer to print the scope turret label or activating a display to display the turret label image, wherein payment information is selected from the group consisting of a user name, a user identifier, a user address, a user email, a user telephone number, user contact information, a credit card number with associated information, a debit card number with associated information, and an identifier for a payment mechanism.
